(19) United States
(12) Patent Application Publication
(10) Pub. No.: US 2025/0376961 A1
(43) Pub. Date: Dec. 11, 2025

(54) METHOD TO CONTROL A VEHICLE PROVIDED WITH A NATURALLY ASPIRATED INTERNAL COMBUSTION ENGINE

(71) Applicant: FERRARI S.P.A., Modena (IT)

(72) Inventors: Stefano VARISCO, Modena (IT); Jacopo CANESTRI, Modena (IT); Daniele GENOVA, Modena (IT); Lorenzo LARAIA, Modena (IT)

(21) Appl. No.: 19/185,341

(22) Filed: Apr. 22, 2025

(30) Foreign Application Priority Data
Apr. 22, 2024 (IT) 102024000009118

(51) Int. Cl. F02D 41/26; F01L 13/00; F02D 41/00; F02P 5/15

(52) U.S. Cl. CPC F02D 41/26; F01L 13/00; F02D 41/0002; F02P 5/1502; F02D 2200/101; F02D 2200/602

(57) ABSTRACT

A method to control a road vehicle provided with a naturally aspirated internal combustion engine, which generates a torque transmitted to at least one drive wheel. The control method comprises the steps of: acquiring a position of an accelerator control; determining a requested torque based on the position of the accelerator control; determining a torque target based on the requested torque; controlling the internal combustion engine so as to pursue the target torque; establishing, based on the requested torque, a growth law, which entails a linear increase in the torque target as a rotational speed of the internal combustion engine increases; and determining the torque target using the growth law.

### CROSS-REFERENCE TO RELATED APPLICATIONS

This patent application claims priority from Italian patent application no. 102024000009118 filed on Apr. 22, 2024, the entire disclosure of which is incorporated herein by reference.

### TECHNICAL FIELD

This invention relates to a method to control a vehicle provided with a naturally aspirated internal combustion engine.

### PRIOR ART

A high-performance internal combustion engine (capable of delivering a maximum torque of several hundred Nm) may exhibit a relatively uneven torque curve (that is, a trend in torque as a function of rotational speed). In other words, as the rotational speed increases, the torque delivered by the internal combustion engine does not always increase linearly with the same gradient, but increases faster at some speeds and increases more slowly at other speeds.

An uneven torque curve makes driving the vehicle more complex during performance driving (that is, when the vehicle's full potential is exploited), as at torque growth peaks the vehicle can have sudden reactions (for example, “fishtailing” due to power-oversteer) that require a high level of driving skill to control properly.

In a turbocharged internal combustion engine, the turbine pressure can be adjusted in real time to try to linearise the torque curve; however, this adjustment cannot be made in a naturally aspirated internal combustion engine.

Patent applications EP1722084A1 and US2005182556A1 describe a method to control a vehicle provided with a naturally aspirated internal combustion engine that involves: acquiring a position of an accelerator control, determining a rotational speed of the internal combustion engine, and determining a target torque to be generated by the internal combustion engine as a function of the position of the accelerator control and as a function of the rotational speed of the internal combustion engine using a static conversion law (that is, one that always remains the same even when the surrounding conditions change).

### DESCRIPTION OF THE INVENTION

The purpose of this invention is to provide a method to control a vehicle provided with a naturally aspirated internal combustion engine; this control method makes driving simpler and more enjoyable and is, at the same time, simple and inexpensive to implement.

According to this invention, a method to control a vehicle provided with a naturally aspirated internal combustion engine is provided according to that set forth in the appended claims.

The claims describe preferred embodiments of this invention forming an integral part of this description.

### BRIEF DESCRIPTION OF THE DRAWINGS

This invention will now be described with reference to the accompanying drawings, which illustrate a non-limiting embodiment thereof, wherein:

FIG. 1 is a schematic plan view of a rear-wheel drive vehicle equipped with a naturally aspirated internal combustion engine;

FIG. 2 is a schematic view of the naturally aspirated internal combustion engine;

FIG. 3 is a block diagram of a control unit of the vehicle in FIG. 1; and

FIG. 4 is a graph that illustrates various possible torque curves of the naturally aspirated internal combustion engine in FIG. 2.

### PREFERRED EMBODIMENTS OF THE INVENTION

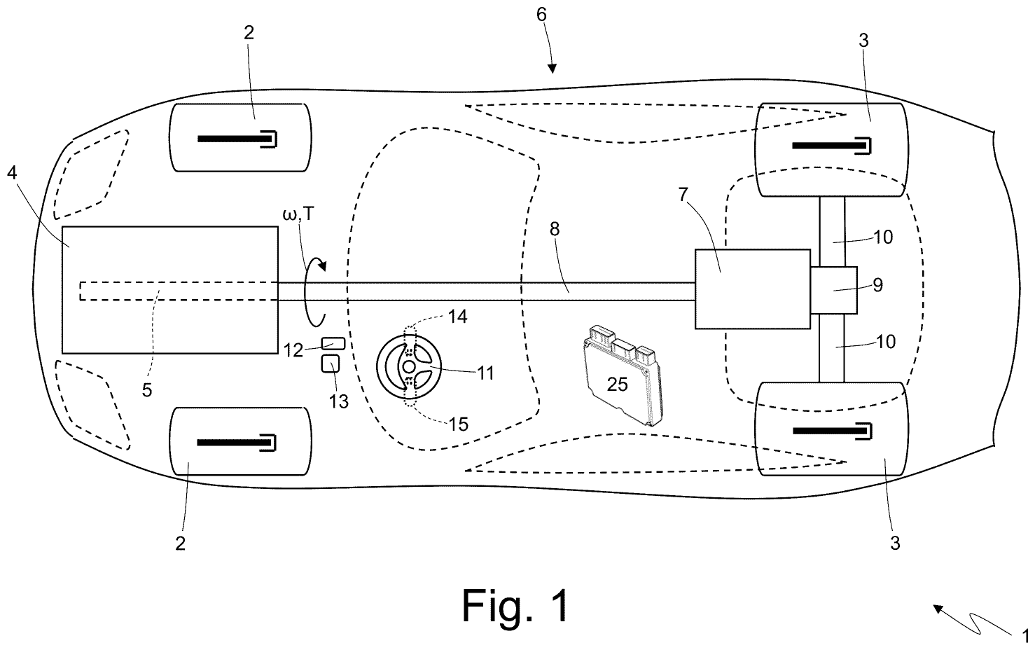

In FIG. 1, the reference number 1 indicates, as a whole, a road vehicle (in particular, a car) equipped with two front wheels 2 and two rear drive wheels 3.

The road vehicle 1 comprises a naturally aspirated internal combustion engine 4, which is arranged in a front position, has a drive shaft 5 that rotates at a rotational speed ω and produces a torque T that is transmitted to the rear drive wheels 3 by means of a transmission 6. The transmission 6 comprises a gearbox 7 arranged at the rear axle and a transmission shaft 8 connecting the drive shaft 5 to an input of the gearbox 7; the gearbox 7 is interposed between the internal combustion engine 4 and the rear drive wheels 3 and has a plurality of gears having different gear ratios. A self-locking differential 9, from which a pair of axle shafts 10 originate, each of which is connected to a rear driving wheel 3, is connected in cascade to the gearbox 7.

As illustrated in FIG. 1, the vehicle 1 comprises a cockpit, inside which is a driver's position equipped with a steering wheel 11, an accelerator pedal (control) 12 and a brake pedal (control) 13. The driver's position also comprises an upshift control 14 and a downshift control 15 that the driver can use to select a gear. The controls 14 and 15 preferably comprise two blades that are connected to the steering wheel 11 and are placed behind the steering wheel 11 rim to be activated without taking the hands off the steering wheel 11.

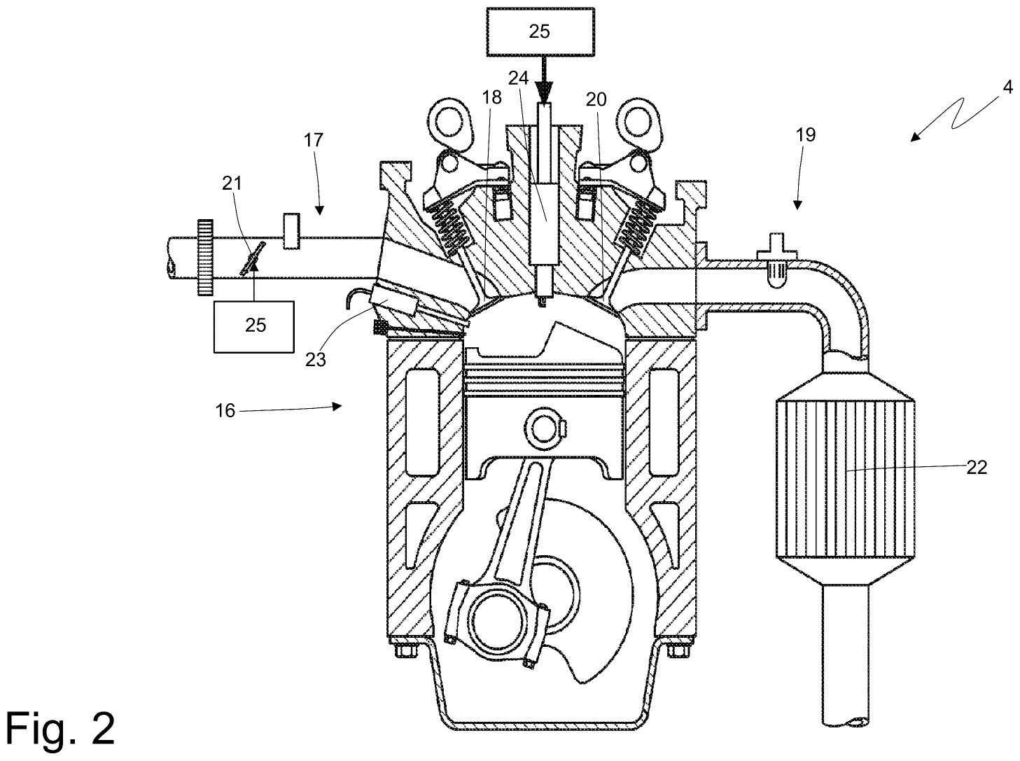

As illustrated in FIG. 2, the naturally aspirated internal combustion engine 4 comprises a plurality of cylinders 16 (only one of which is illustrated in FIG. 2), each of which is connected to an intake duct 17 via two intake valves 18 (only one of which is illustrated in FIG. 2) and is connected to an exhaust duct 19 via two exhaust valves 20 (only one of which is illustrated in FIG. 2). An intake manifold may be included along the intake duct 17 and near the cylinders 16 and, similarly, along the exhaust duct 19 and near the cylinders 16, there may be an exhaust manifold.

A throttle valve 21 is arranged along the intake duct 17 to regulate the air flow rate through the intake duct 17. At least one combustion gas treatment device 22 is arranged along the exhaust duct 19 to reduce the concentration of pollutants before the combustion gases are released into the atmosphere.

The internal combustion engine 1 comprises an injection system, which injects fuel into the cylinders 16 via corresponding fuel injectors 23. In other words, the injection system comprises a plurality of fuel injectors 23, each of which injects directly into a respective cylinder 16 and receives the pressurised fuel from a common channel called the “common-rail”.

The internal combustion engine 1 comprises an ignition system, which cyclically ignites the mixture in the cylinders 16 at the end of the compression phase and comprises at least one spark plug 24 for each cylinder 16.

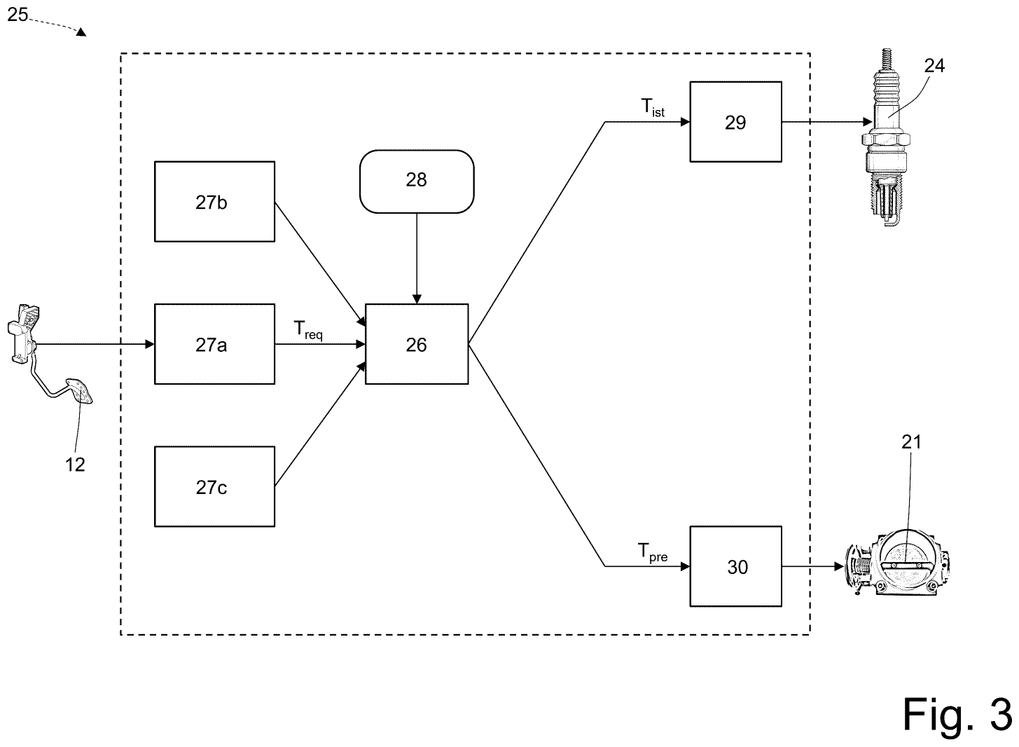

The road vehicle 1 comprises a control unit 25 that, among other things, oversees the operation of the internal combustion engine 4 and the gearbox 7. According to what is illustrated in FIG. 3, the control unit 25 implements, among other things, the function of a torque request coordinator 26 to receive torque requests from a series of adjustment systems 27 and consequently generate a control signal for controlling the actuators that affect the generation of torque in the internal combustion engine 4.

This control signal comprises an instantaneous torque control value Tᵢₛₜ that is used to control the actuators that have a fast effect on the generation of the torque and a predicted torque control value Tₚᵣₑ that is used to control the actuators that have a slow effect on the generation of torque. Specifically, in the internal combustion engine 4, the instantaneous torque control value Tᵢₛₜ is used to control the spark advance, that is, to change an instant of spark plug 24 ignition (i.e., a spark plug 24), while the predicted torque control value Tₚᵣₑ is used to control the position of the throttle valve 21. If there is an intake valve 18 stroke shifter, the predicted torque control value Tₚᵣₑ is also used to control the stroke of the intake valves 18.

The adjustment system 27a utilises the position of the accelerator pedal 12 to determine a torque request from the driver. Specifically, the adjustment system 27a acquires a position of the accelerator pedal 12 and then determines a requested torque T_{req} depending on the position of the accelerator pedal 12. The adjustment system 27b controls the idle speed and its primary objective is to prevent the rotational speed ω from falling outside a desired value (that is, the idle value). The adjustment system 27c implements the anti-skid function of the rear drive wheels 3 by reducing the torque when the rear drive wheels 3 skid.

In use, the control unit 25 (via the adjustment system 27a) acquires a position of the accelerator pedal 12 and then determines the requested torque T_{req} as a function of the position of the accelerator pedal 12; subsequently, the control unit 25 (via the coordinator 26) determines a torque target as a function (also) of the requested torque T_{req} and then controls the internal combustion engine 4 to pursue the torque target.

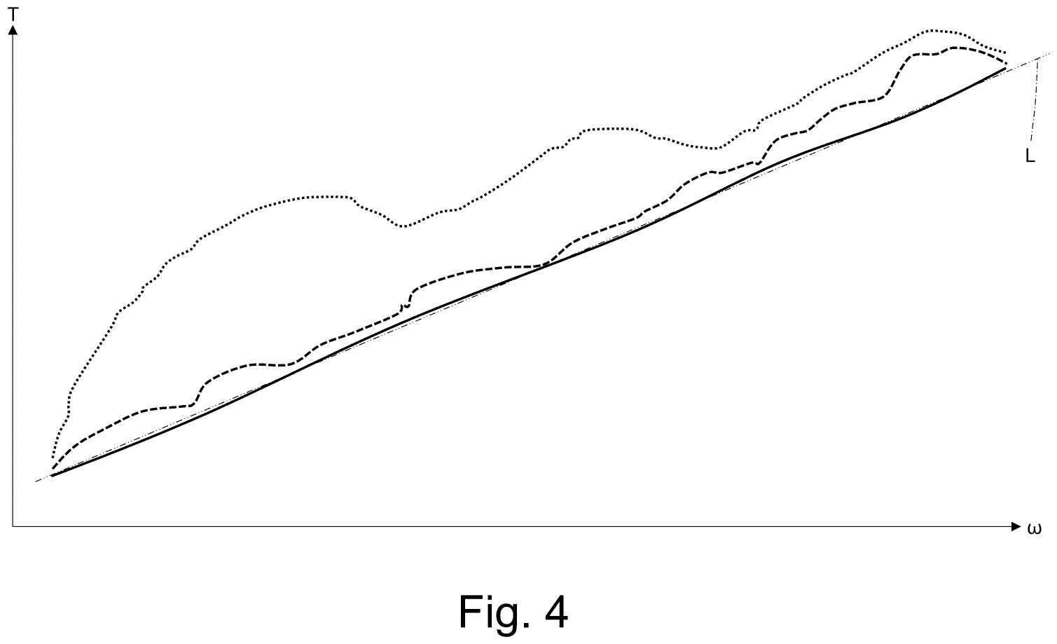

The control unit 25 comprises a linearising system 28 that establishes, as a function of the requested torque T_{req}, a growth law L (illustrated in FIG. 4) that provides for a linear increase in the torque target as the rotational speed ω of the internal combustion engine 4 increases. In other words, the growth law L is a straight line on the plane having the rotational speed ω on the x-axis (that is, the absolute value of the rotational speed ω from the minimum possible to the maximum possible) and the torque target on the y-axis (that is, the absolute value of the torque target). The coordinator 26 of the control unit 25 determines the torque target using the growth law L and a function of the rotational speed ω only (that is, the requested torque T_{req} is used to determine the growth law L while the torque target is determined using the growth law L and as a function of the rotational speed ω only).

Depending on the torque target, the coordinator 26 generates the instantaneous torque control value Tᵢₛₜ that is used to control the actuators that have a fast effect on torque generation and generates the predicted torque control value Tₚᵣₑ that is used to control the actuators that have a slow effect on torque generation. Specifically, the instantaneous torque control value Tᵢₛₜ is supplied to a controller 29 that drives the spark plugs 24 (and thus establishes the corresponding spark advance) while the predicted torque control value Tore is supplied to a controller 29 that drives the throttle valve 21 (and thus establishes the position of the throttle valve 21).

According to a preferred embodiment, the slope of the growth law L increases as the requested torque T_{req} increases and vice versa. That is, the growth law L entails, given the same rotational speed ω, a greater torque target as the requested torque Treg increases and vice versa.

According to a preferred embodiment, the torque target is determined using the growth law L only when the requested torque T_{req} is greater than a threshold value, that is, when the accelerator pedal 12 is fully depressed (“to the floor” or close to this position).

According to a preferred embodiment, the control unit 25 acquires an engaged gear of the gearbox 7 and determines the torque target using the growth law L only when a gear having a gear ratio below a threshold value is engaged in the gearbox 7 (that is, when a “short” gear is engaged in the gearbox 7, for example the first or second gear).

According to one preferred embodiment, the torque target is determined using the growth law L only when the rotation speed ω is below a threshold value. In particular, this threshold value of the rotational speed ω is set in such a way that below this threshold value, the torque is always increasing as the rotational speed ω increases.

At each rotational speed ω, the torque target provided by the growth law L is less than a maximum torque that can be generated by the internal combustion engine 4 (which is determined in advance, that is once and for all during a design and tuning phase of the internal combustion engine 4). That is, the growth law L “limits” the performance of the internal combustion engine 4 by accepting the generation of a torque lower than the maximum torque that can be generated by the internal combustion engine 4 at all rotational speeds ω in order to obtain linear growth of the torque as the rotational speed ω increases.

What has been described above is clearly visible in FIG. 4 wherein the plane that has the rotational speed ω on the y-axis and the torque T on the x-axis shows the following: the perfectly linear growth law L (in dashes and dots); the torque generated by the internal combustion engine 4 using the growth law L both by adjusting the spark advance and by adjusting the position of the throttle valve 21 (in a continuous line); the torque generated by the internal combustion engine 4 using the growth law L by adjusting only the position of the throttle valve 21 (dashed line); and the torque generated by the internal combustion engine 4 without using the growth law L (dotted line) and corresponding to the maximum torque that can potentially be generated by the internal combustion engine 4.

From what is illustrated in FIG. 4, it is clear how the growth law L limits the performance of the internal combustion engine 4 (the reduction in torque between the maximum performance obtainable on the dotted line and the growth law L is clear) and it is equally clear how the growth law L allows for a linear (therefore predictable and much more easily manageable) growth in torque as the rotational speed ω increases.

From the above, it is clear that the growth law L remains the same as long as the requested torque T_{req} remains the same (that is, does not change); in other words, the growth law L is determined as a function of the requested torque T_{req} and therefore with the same requested torque T_{req}, the growth law L remains the same. Obviously, even if the growth law L remains the same (that is, if the requested torque T_{req} remains the same), the torque target varies (increases or decreases) as the rotational speed ω varies (increases or decreases).

The embodiments described herein may be combined with each other without departing from the scope of protection of this invention.

The control method described above has numerous advantages.

First of all, the control method described above simplifies the driving of the vehicle 1 during performance driving as it makes the growth of torque linear (hence predictable and easily manageable) as the rotational speed w increases. In this regard, it is important to note that the linearisation of the torque as the rotational speed ω increases penalises the performance of the internal combustion engine 4 in theory. However, this penalisation is more theoretical than practical in that when the “short” gears are engaged, the maximum torque that can be generated by the internal combustion engine 4 is almost always greater than the torque that the rear drive wheels 3 are able to discharge to the ground and, therefore, in any case not all the maximum torque that can be generated by the internal combustion engine 4 would be exploited to avoid the skidding of the rear drive wheels 3 (which determines a loss of performance and therefore should be avoided).

In addition, the control method described above is simple and inexpensive to implement, as it does not require the addition of any physical components and is completely implemented using software and exploiting the architectures already normally present on-board road vehicles 1. It is important to note that the control method described above does not require either a high computing capacity or an extensive amount of memory and, therefore, it can be implemented in a known control unit without the need for upgrades or enhancements.

### LIST OF REFERENCE NUMBERS IN THE FIGURES

1 road vehicle
2 front wheels
3 rear wheels
4 internal combustion engine
5 drive shaft
6 transmission
7 gearbox
8 transmission shaft
9 differential
10 semi-axles
11 steering wheel
12 accelerator pedal
13 brake pedal
14 upshift control
15 downshift control
16 cylinders
17 intake duct
18 intake valve
19 exhaust duct
20 exhaust valve
21 throttle valve
22 treatment device
23 control unit
24 spark plug
25 control unit
26 coordinator
27 adjustment systems
28 linearising system
29 controller
30 controller
ω rotational speed
T torque
Tᵢₛₜ instantaneous torque control value
Tₚᵣₑ predicted torque control value
T_{req} requested torque
L growth law

1. A method to control a road vehicle (1) provided with a naturally aspirated internal combustion engine (4), which generates a torque transmitted to at least one drive wheel (3); the control method comprises the steps of:
determining in advance a maximum torque that can be generated by the internal combustion engine (4) at each rotational speed (ω) of the internal combustion engine (4);
acquiring a position of an accelerator control (12);
determining a rotational speed (ω) of the internal combustion engine (4);
determining a requested torque (T_{req}) based on the position of the accelerator control (12);
determining a torque target based on the requested torque (T_{req});
controlling the internal combustion engine (4) so as to pursue the target torque;
establishing, based on the requested torque (T_{req}), a growth law (L), which entails a linear increase in the torque target as a rotational speed (ω) of the internal combustion engine (4) increases so that the growth law (L) is a straight line on the plane having the rotational speed (ω) on the x-axis and the torque target on the y-axis and so that, at every rotational speed (ω), the torque target provided by the growth law (L) is lower than the maximum torque that can be generated by the internal combustion engine (4); and
determining the torque target using the growth law (L) only as a function of the rotational speed (ω) of the internal combustion engine (4) so that, with the same requested torque (T_{req}) and, thus, with the same growth law (L), the torque target changes as the rotational speed (ω) of the internal combustion engine (4) changes.

2. The control method according to claim 1, wherein an incline of the growth law (L) increases as the requested torque (T_{req}) increases and vice versa.

3. The control method according to claim 1, wherein the growth law (L) entails, given the same rotational speed (ω), a greater torque target as the requested torque (T_{req}) increases and vice versa.

4. The control method according to claim 1 and comprising the steps of:
generating, based on the torque target, a value (Tᵢₛₜ) for the control of the instantaneous torque, which is used to control actuators that have a quick effect on the generation of the torque; and
generating, based on the torque target, a value (Tₚᵣₑ) for the control of the predicted torque, which is used to control actuators that have a slow effect on the generation of the torque.

5. The control method according to claim 4, wherein:
the internal combustion engine (4) comprises at least one cylinder (16), a spark plug (24) coupled to the cylinder (16) to ignite a mixture inside the cylinder and an intake system, which is configured to supply air to the cylinder (16) and has a throttle valve (21), which adjusts the air flow rate taken in;
the value (Tᵢₛₜ) for the control of the instantaneous torque is used to establish a spark advance of the spark plug (24); and
the value (Tₚᵣₑ) for the control of the predicted torque is used to establish an opening of the throttle valve (21).

6. The control method according to claim 5, wherein the value (Tₚᵣₑ) for the control of the predicted torque is also used to establish a stroke of the intake valve (18).

7. The control method according to claim 1, wherein the torque target is determined using the growth law (L) only when the requested torque (T_{req}) exceeds a threshold value.

8. The control method according to claim 1, wherein the torque target is determined using the growth law (L) only when the rotation speed (ω) is below a threshold value.

9. The control method according to claim 1, wherein:
the vehicle (1) comprises a gearbox (7), which is interposed between the internal combustion engine (4) and the drive wheel (3) and has a plurality of gears having different gear ratios;
an engaged gear of the gearbox (7) is acquired; and
the torque target is determined using the growth law (L) only when in the gearbox (7) there is engaged a gear having a gear ratio below a threshold value.

10. The control method according to one of claim 1, wherein the growth law (L) remains the same as long as the requested torque (T_{req}) remains the same or does not change.

11. The control method according to claim 10, wherein, even if the growth law (L) remains the same, that is, the requested torque (T_{req}) remains the same, the torque target changes as the rotational speed (ω) changes.
